(19) United States
(12) Patent Application Publication
(10) Pub. No.: US 2014/0168207 A1
(43) Pub. Date: Jun. 19, 2014

(54) 3D USER INTERFACE DISPLAY SYSTEM AND METHOD

(71) Applicant: MStar Semiconductor, Inc., Hsinchu Hsien (TW)

(72) Inventors: Meng Pu, Hsinchu County (TW); Ming-Yong Sun, Hsinchu County (TW)

(73) Assignee: MStar Semiconductor, Inc., Hsinchu Hsien (TW)

(21) Appl. No.: 14/132,102

(22) Filed: Dec. 18, 2013

(30) Foreign Application Priority Data
Dec. 18, 2012 (CN) 201210550399.1

(51) Int. Cl. G06T 15/00

(52) U.S. Cl. CPC G06T 15/005
USPC 345/419

(57) ABSTRACT

A three-dimensional (3D) user interface display system is provided. The system includes a surface type determination module, an auto-stereoscope module, a rendering module, a frame buffer module, a graphics processor and a display module. The surface type determination module determines whether each visible surface is a two-dimensional (2D) or 3D surface. The auto-stereoscope module performs an auto-stereoscopic process on the 2D surface according to a mode adopted by the 3D surface. The rendering module renders the 3D surface or the auto-stereoscopically processed 2D surface from the auto-stereoscope module. The frame buffer module frame buffers the rendered by the rendering module. The graphics processor interleaves or interpolates the frame buffered surface. The display module displays a final surface.

This application claims the benefit of People's Republic of China application Serial No. 201210550399.1, filed Dec. 18, 2012, the subject matter of which is incorporated herein by reference.

### BACKGROUND OF THE INVENTION

1. Field of the Invention

The invention relates to a general user display system of an interface display technology of an electronic apparatus, and more particularly to a three-dimensional (3D) user interface system and an associated method.

2. Description of the Related Art

With continual progresses of smart terminals, the Android operating system on portable handsets has become a mainstream and dominant operating system. Meanwhile, user interfaces are also becoming more sophisticated with the ever-enhancing hardware performance. Due to certain restrictions, it is unlikely that two-dimensional (2D) interfaces can be drastically enriched. Conventional 3D user interfaces, although offering sensational enhancements, are projections of 3D surfaces on to a 2D space, and are thus essentially 2D user interfaces that lack realistic stereoscopic effects for satisfying personalized requirements on user interfaces. Therefore, designs of 3D user interfaces based on the Android operating system are regarded as a development trend. On the other hand, since conventional user interfaces have yet to coexist with 3D user interfaces for 3D user interface applications, there is a need for a solution to skillfully integrate the two types of interfaces that are quite different in processing details.

SurfaceFlinger is an Android surface management server. Through a user interface for a surface management application program, SurfaceFlinger may set an appearance and behaviors of an application program interface (API). Further, a graphics engine, providing processing and display of an API with a fundamental hardware support, performs a series of complicated mathematical calculations and geometric conversions, and outputs the user interface to a display device.

FIG. 1 shows a flowchart for displaying a user interface in the prior art. After confirming an image of a user interface in step S11, a management server superimposes all visible surfaces and renders visible parts in step S12. A result is stored to a frame buffer for frame buffering in step S13. A graphics processor then performs mathematical calculations and geometric conversions on the frame buffered image in step S14, and outputs a final image to a screen to display the image on a display panel in step S15.

However, the above method suffers from certain drawbacks. Take a top-bottom surface for example. A surface processed by the management server is a complete image having a top half and a bottom half with parallax between the two. Without the mathematical calculations and the geographic conversions performed by the graphics processor, the result outputted to the screen still appears as a user interface having a top half and a bottom half. Such an approach cannot support a 3D user interface. This issue can be solved by interleaving of odd and even fields. However, other issues may arise when the visible surfaces contain a 2D user interface in addition to a 3D user interface. FIG. 2 shows a schematic diagram of displaying visible surfaces including a 3D user interface and a 2D user interface in the prior art. A surface 201 represents the 3D user interface, and a surface 202 represents a 2D user interface. A management server superimposes the surfaces 201 and 202 and renders a result into a surface 203. When a graphics processor interleaves odd and even fields of the surface 203 to generate a surface 204, abnormalities will occur in the 2D user interface in surface 204. More particularly, when interleaving odd and even fields, the user interface at the odd fields is stretched in a way that the corresponding user interface becomes invisible in the even fields. In a worse scenario, the user interface in the odd and even fields is superimposed and becomes unidentifiable.

### SUMMARY OF THE INVENTION

The present invention is directed at providing a 3D user display system for displaying a 3D user interface on an electronic apparatus.

According to an embodiment of the present invention, a 3D user interface display system comprises: a surface type determination module, a management server, a frame buffer module, a graphics processor and a display module. The surface type determination module determines whether a visible surface is a 2D surface or a 3D surface. The management server, for drawing and rendering the visible surfaces, comprises an auto-stereo module and a rendering module. The auto-stereoscope module performs an auto-stereoscopic process on the 2D surface in the visible surfaces. The rendering module renders the visible surfaces. The frame buffer module frame buffers the surface rendered by the rendering module. The graphics processor performs a graphics process on the frame buffered surface. The display module displays a final surface processed by the graphics processor.

According to another embodiment of the present invention, a 3D user interface display method for displaying a 3D user interface on an electronic apparatus is provided. The 3D user interface display method comprises: step S1: determining whether each visible surface is a 2D surface or a 3D surface; step S2: drawing the visible surfaces, comprising step S20 of performing an auto-stereoscopic process on the 2D surface; step S3: rendering the visible surfaces; step S4: frame buffering the surfaces rendered in step S3; step S5: performing a graphics process on the frame buffered surfaces in step S4 according to an attribute of the surfaces; and step S6: displaying the surfaces processed in step S5.

In the 3D user interface display system and associated method of the present invention, different operations are performed for surfaces of different attributes according to whether the surfaces are 2D or 3D surfaces, so as to better display a 3D user interface on an electronic apparatus.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a flowchart for displaying a user interface in the prior art;

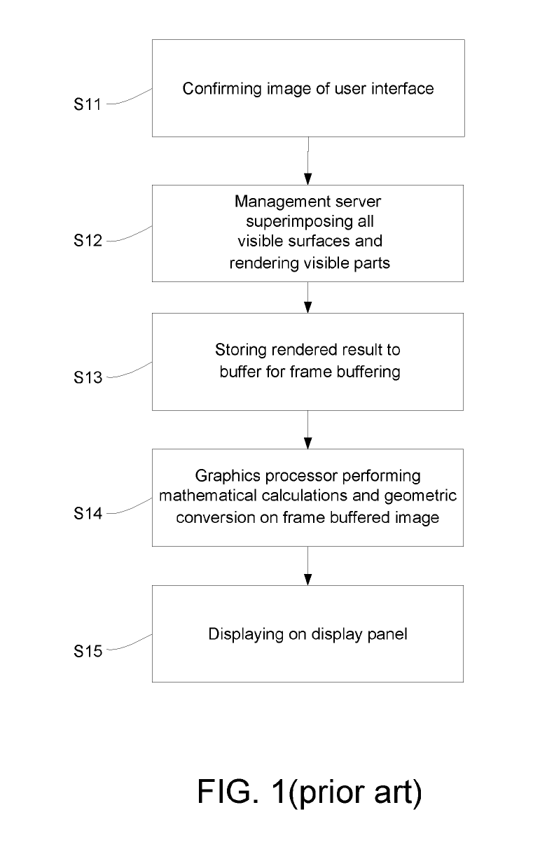

FIG. 2 is a schematic diagram of displaying a visible surface containing both a 3D surface and a 2D surface in the prior art;

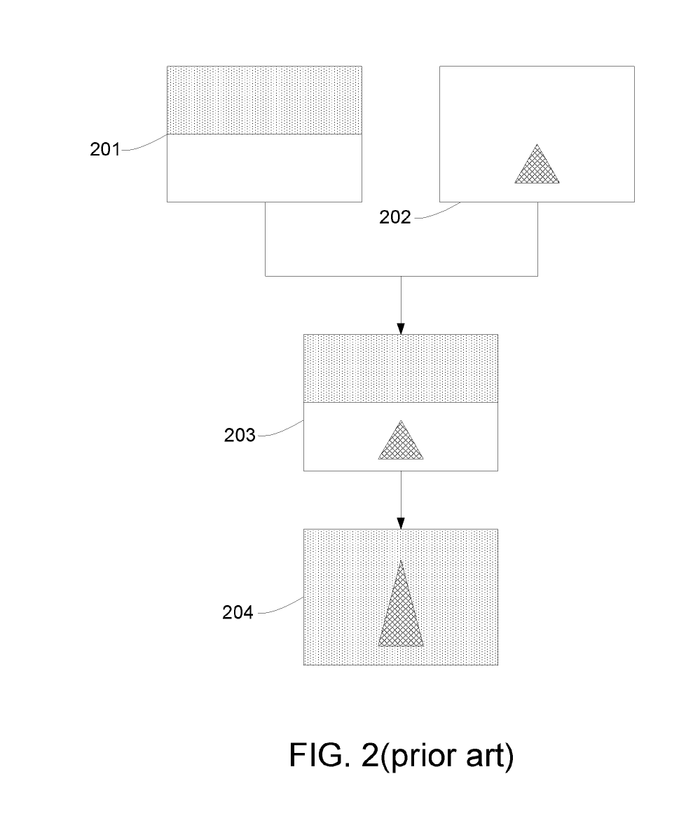

FIG. 3 is a block diagram of a 3D user interface display system according to an embodiment of the present invention;

FIG. 4 is a schematic diagram for performing an auto-stereoscopic process on a 2D surface according to an embodiment of the present invention;

FIG. 5 is a schematic diagram of a first application scenario according to an embodiment of the present invention;

FIG. 6 is a schematic diagram of displaying a user interface in a first application scenario according to an embodiment of the present invention;

FIG. 7 is a schematic diagram of a second application scenario according to an embodiment of the present invention;

FIG. 8 is a schematic diagram of a user interface in a second application scenario according to an embodiment of the present invention;

FIG. 9 is a flowchart of an attribute configuration module setting an attribute of a surface according to an embodiment of the present invention; and

FIG. 10 is a flowchart for drawing a visible surface by a management server according to an embodiment of the present invention.

### DETAILED DESCRIPTION OF THE INVENTION

Preferred embodiments of the present invention are described below with the accompanying drawings.

### First Embodiment

The present invention discloses a method for offering a 3D user interface with realistic stereoscoped effects on an Android smart TV (also applicable to other operating system and other electronic apparatuses). Through parallax of both eyes, a user may experience immersive sensations. Further, a conventional user interface (corresponding to a 2D surface) may become abnormal due to special processes on a 3D user interface (corresponding to a 3D surface). For example, in a top-down surface (such mode is given as an example for illustrating the present invention below), the conventional user interface may become visible to only one eye due to interleaving of odd and even fields or even become unidentifiable. The present invention offers a solution for solving the above issues and is capable of skillfully integrating the user interfaces based on 2D and 3D surfaces.

In the present invention, an auto-stereoscopic process is added to a management server, and a graphics processor also determines whether to interleave the odd and even fields. In the auto-stereoscopic process, to coordinate with the 3D user interface, a conventional user interface is compressed and divided into a top part and a bottom part, which are then individually drawn and rendered. Under the coexistence of the 3D user interface and the conventional user interface, an auto-stereoscopic process is performed on the conventional user interface according to a mode adopted by the 3D user interface. An auto-stereoscopically processed surface is rendered by the management server and forwarded to the graphics processor, which then interleaves odd and even fields of the rendered surface or interpolates the rendered surface and outputs a result to a display panel. The conventional user interface and the 3D user interface processed by the management server are integrated by the graphics processor. The top part and the bottom part outputted by the management server are respectively a complete image, and can be integrated by the graphics processor to yield a user-expected display effect.

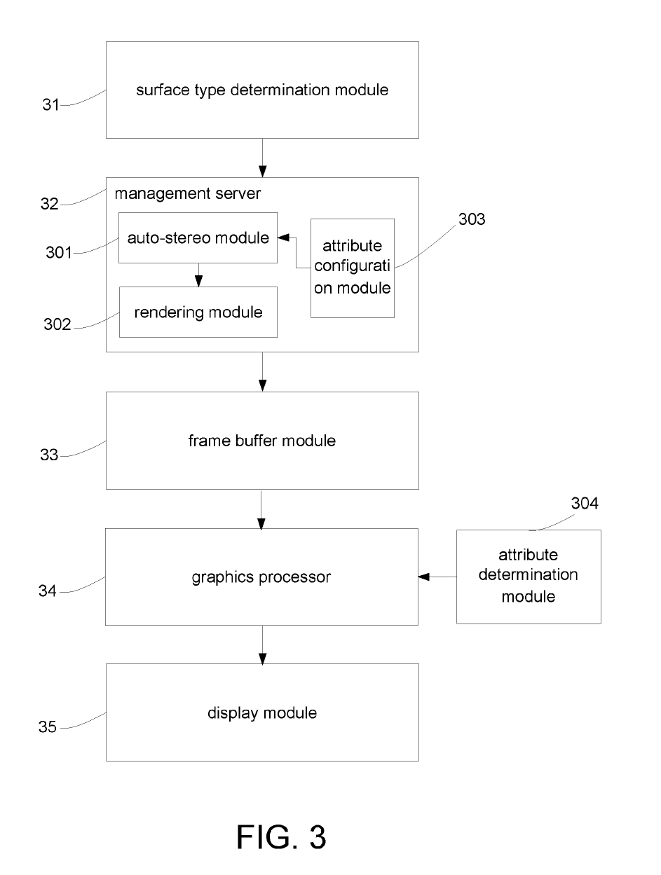

FIG. 3 shows a block diagram of a 3D user interface display system according to an embodiment of the present invention. Referring to FIG. 3, the system comprises a surface type determination module 31, a management server 32, an auto-stereoscope module 301, a rendering module 302, a frame buffer module 33, a graphics processor 34, a display module 35, an attribute configuration module 303, and an attribute determination module 304.

The surface type determination module 31 determines whether each visible surface is a 2D surface or a 3D surface. An image displayed by the system may be formed by superimposing multiple visible surfaces. The surface type determination module 31 determines an attribute of each visible surface according to a configured sequence.

The management server 32 comprises the attribute configuration module 303, the auto-stereoscope module 301 and the rendering module 302, for drawing, rendering and outputting surfaces to the frame buffer 33, respectively.

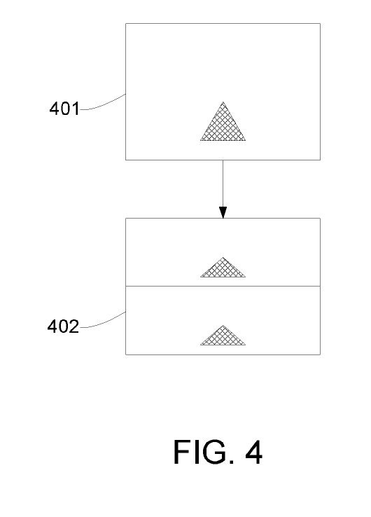

FIG. 4 shows a schematic diagram of performing an auto-stereoscopic operation on a 2D surface according to an embodiment of the present invention. The auto-stereoscope module 301 performs an auto-stereoscopic operation on the 2D surface (a surface 401) among the visible surface according to a mode adopted by a 3D surface. More specifically, the auto-stereoscope module 301 compresses the entire 2D surface 401, divides the 2D surface 401 into a top part and a bottom part, draws the top part and the bottom part individually, and combines the top part and bottom part into a complete surface (a surface 402). Alternatively, the 2D surface 401 may be compressed, and divided into a left part and a right part. The left part and the right part are drawn individually and combined into a complete surface.

The attribute configuration module 303 sets an auto-stereoscopic attribute mAutoStereo for the surfaces. Associated details are to be described shortly.

The rendering module 302 renders the 3D surface or the 2D surface auto-stereoscopically processed by the auto-stereoscope module 301.

The frame buffer module 33 frame buffers the surface rendered by the rendering module 302.

The graphics processor 34 processes the frame buffered surface. Further, the graphics processor 34 may be applied with the attribute determination module 304. That is, the attribute determination module 304 determines the attribute of the surface, with the attribute corresponding to the processing method of the graphics processor 34. According to different attributes, the graphics processor 34 may interleave odd and even fields of the surface or interpolate the surface. In practice, for example, the function of the attribute determination module 304 may be realized by the attribute configuration module 303.

Therefore, the graphics processor 34 further comprises an odd-even-field interleaving module (not shown) for interleaving the odd and even fields of the frame buffered surface. The odd-even-field interleaving module interleaves the odd and even fields of the two parts of the frame buffered surface to obtain a complete surface. Odd and even fields have different polarizations. Through a polarizer, two images having parallax is perceived by left and right eyes to form a surface with a stereoscopic effect creating a sense of depth in the human brain.

The graphics processor 34 further comprises an interpolation module (not shown) for interpolating the frame buffered surface. The interpolation module interpolates the two parts of an image and sequentially outputs the interpolated parts as two frames. The former frame is visible to the left eye, whereas the latter frame is visible to the right eye. With a pair of glasses of left and right lenses having an alternating function, a user is allowed to receive corresponding frames. The interpolation module further sends a synchronization signal for controlling the switch operation of the left and right lenses of the glasses. As such, a time difference between time points at which the two frames reach the left and right eyes is minute and can hardly be noticed, which equivalent to the left and right eyes perceiving the frames as having parallax almost at the same time, thus generating a stereoscopic effect.

The display module 35 displays the surface processed by the graphics processor.

Two application scenarios corresponding to different processing modes of the graphics processor 34 according to an embodiment of the present invention are given below.

### Scenario One: Interleaving of Odd and Even Fields

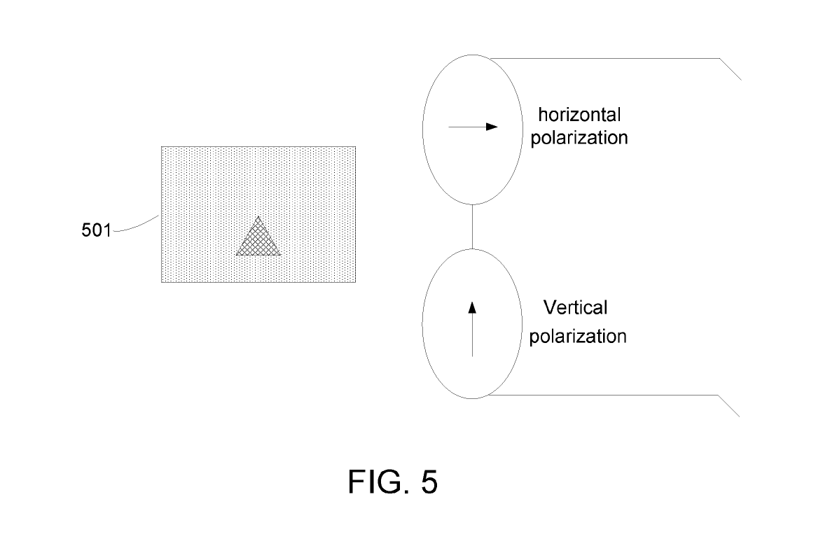

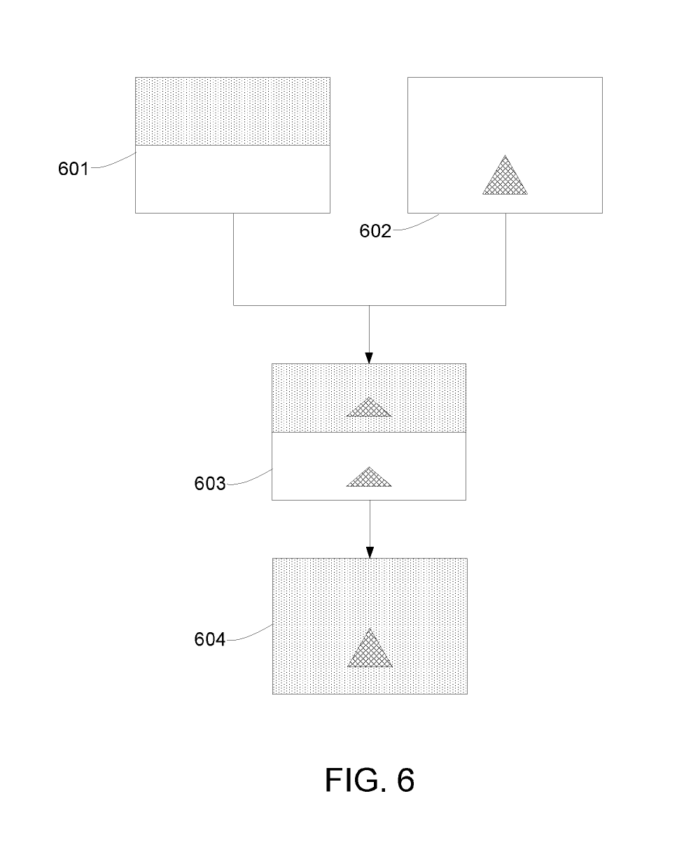

FIG. 5 shows a schematic diagram of a first application scenario according to an embodiment of the present invention. In such an application scenario, the odd-even-field interleaving module in the graphics processor 34 interleaves odd and even fields of the top part and the lower part of the surface (e.g., a surface 402 in FIG. 4) rendered and outputted by the management server 32. Due to different polarizations of the odd and even fields, the odd and even fields are polarized by the glasses with polarizers shown at the right in FIG. 5 to form an interleaved image 501, so that the left and right eye perceive two images having parallax to form a stereoscopic surface giving a stereoscopic effect and sense of depth in the human brain. FIG. 6 shows a schematic diagram of displaying a user interface in a first application scenario according to an embodiment of the present invention. Referring to FIG. 6, a surface 601 and a surface 602 are processed into a surface 603 by the auto-stereoscope module 301 and the rendering module 302 in the management server 32. A surface 604 is obtained from interleaving the odd and even fields of the surface 603 by the odd-even-field interleaving module in the graphics processor 34. The surface 604 corresponds to the image 501 in FIG. 5, and is a stereoscopic surface that can be perceived by utilizing the polarized glasses in FIG. 5.

### Scenario Two: Frame Sequence

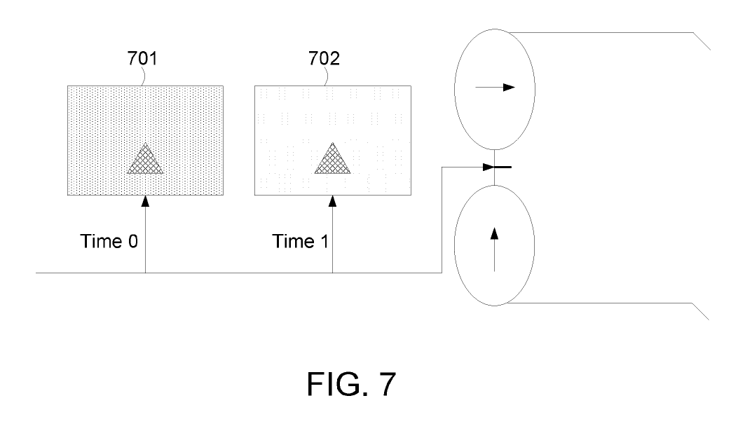

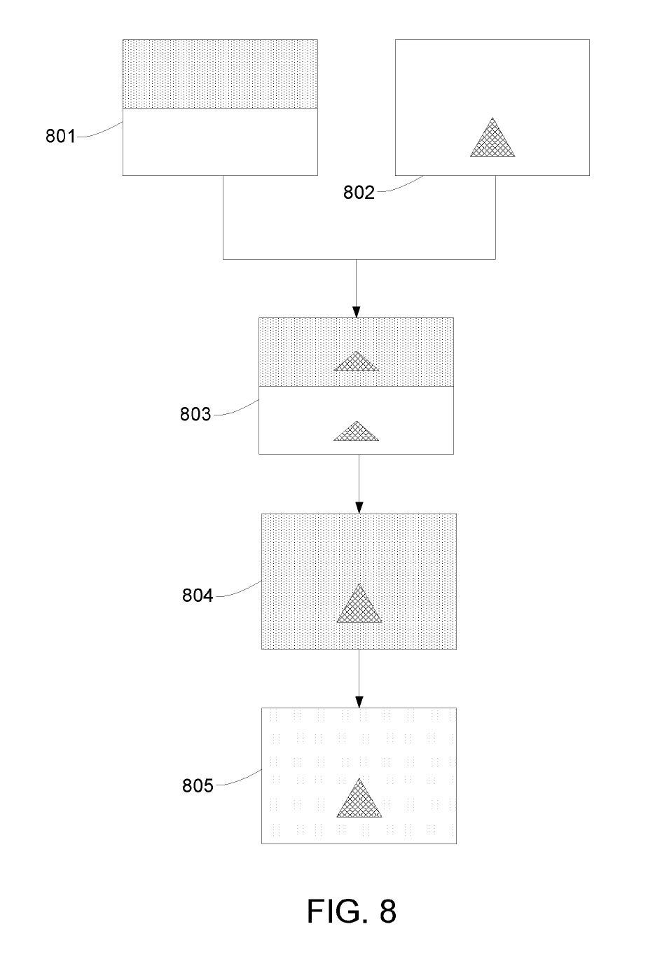

In such an application scenario, the graphics processor 34 interpolates a top part and a bottom part of an image, and sequentially outputs the interpolated parts as two frames. The former frame is visible to only the left eye, and the latter frame is visible to only the right eye. FIG. 7 shows a schematic diagram of a second application scenario according to an embodiment of the present invention. In FIG. 7, the polarized glasses of left and right lenses having an alternating switch function receive corresponding frame sequences, respectively. The graphics processor 34 sends synchronization signals Time0 and Time1 to control the switch operation of the left and right lenses of the glasses. Thus, with controllers receiving the synchronization signals at the left and right lenses of the glasses, the time difference between the time points at which the two frames are received is extremely small and is almost imperceptible by the naked eyes. Due to visual persistence, the left and right eyes perceive two graphic images 701 and 702 almost at the same time in a way that a stereoscopic effect is generated. FIG. 8 shows a schematic diagram of a user interface in a second application scenario according to an embodiment of the present invention. Processing details of surfaces 801, 802 and 803 are the same as those of the surfaces 601, 602 and 603, and shall be omitted herein. A difference in the second scenario is that, the interpolation module in the graphics processor 34 interpolates a top part and a bottom part of the surface 803, and sequentially outputs the interpolated parts as two frames (i.e., surfaces 804 and 805), which correspond to the surfaces 701 and 702 in FIG. 7. With the glasses in FIG. 7, a stereoscopic surface can be observed. In the embodiment, an example of interpolating the top part and the bottom part is given for explaining the present invention, not limiting the present invention. In other embodiments, other interpolation approaches may also be employed.

In the present invention, different attributes are designed in an application program for the two different scenarios above. The graphics processor 34 determines whether to interleave odd and even fields or to interpolate according to the attribute. How an application program sets the attribute is given below.

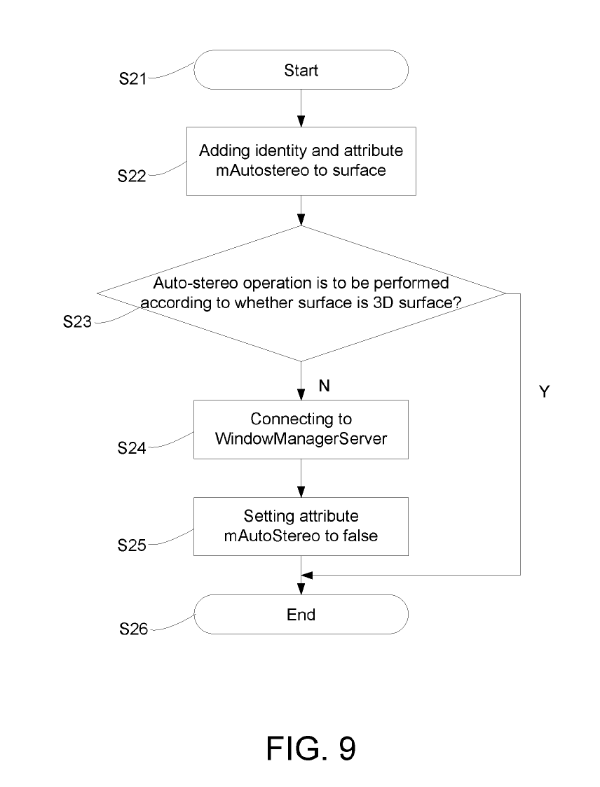

Details of an application program setting an attribute by the structure in FIG. 3 and a process in FIG. 9 are described as follows. FIG. 9 is a flowchart of the attribute configuration module 303 in FIG. 3 setting an attribute of a surface.

In step S21, the process begins, and a surface of a user interface is established.

In step S22, an identity attribute and a stereoscopic attribute mAutoStereo of the surface are added. The management server 32 assigns an identity for uniquely marking the surface, and the mark can be obtained by calling a function getIdentity( ). As the interface of the function is a private member, a public interface is required for the use of the application. As such, an interface name getIdentityForAutoStereoMode( ) is generated. In the code, a stereoscopic attribute mAutoStereo is added for the surface to represent whether the surface requires an auto-stereoscopic operation. The stereoscopic attribute mAutoStereo is default to “true”. In a WindowManagerService, an IPC interface setAutoStereoMode( ) is further added to set the attribute. Therefore, to call the above interface, a connection with the WindowManagerService needs to be first established.

In step 23, whether an auto-stereoscopic operation is required is determined according to whether the surface is a 3D surface. When the surface is a complete 2D surface, an auto-stereoscopic operation needs to be performed to prevent abnormalities in subsequent processes. Thus, the default setting of the stereoscopic attribute mAutoStereo is utilized and need not be modified, and the process proceeds to step S26 to end. When the surface is a 3D surface, which is usually an image drawn by OpenGL and contains a top part and a bottom part with parallax, no auto-stereoscopic operation is required. The stereoscopic attribute mAutoStereo is then set to “false”, followed by performing steps S24 and S25.

In step S24, a connection with the WindowManagerService is established. The IPC interface setAutoStereoMode( ) for setting the stereoscopic attribute mAutoStereo is added in the WindowManagerService, and so a connection with the WindowManagerService needs to be first established in order to call the interface.

In step S25, the stereoscopic attribute mAutoStereo is set to “false”.

The process ends in step S26.

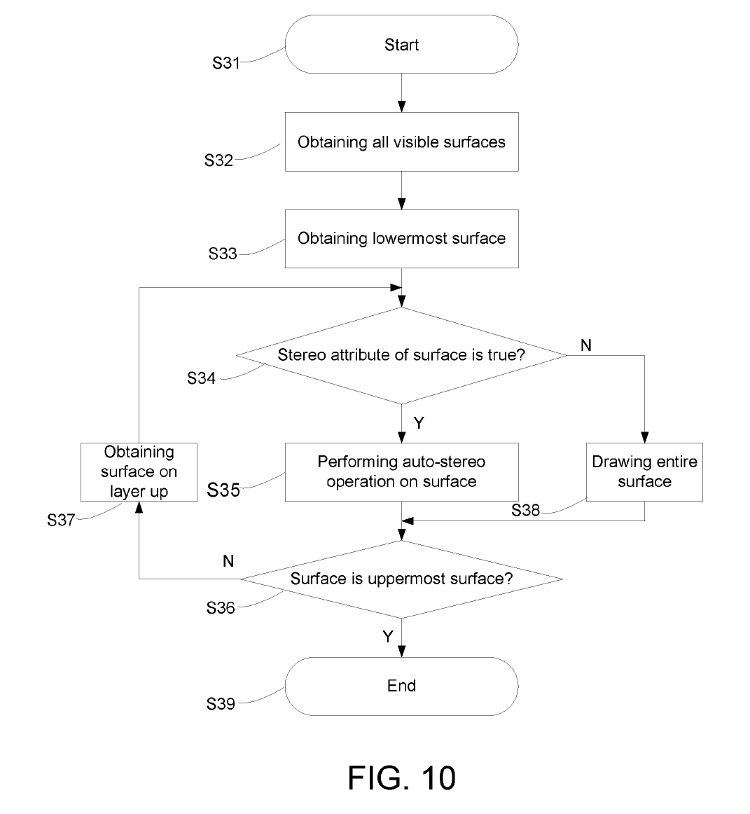

When the stereoscopic attribute mAutoStereo of all the visible surfaces are set, the management server 32 starts drawing. FIG. 10 shows a flowchart of a management server drawing a visible surface according to an embodiment of the present invention.

The process beings in step S31.

In step S32, all visible surfaces are obtained. In step S32, the stereoscopic attribute mAutoStereo of all visible surfaces have been set by the attribute configuration module 303.

In step S33, the management server 32 first obtains the lowermost surface.

In step S34, it is determined whether the stereoscopic attribute mAutoStereo of the obtained surface is “true”. Step S35 is performed when a determination result is affirmative, or else step S38 is performed when the determination result is negative.

In step S35, the auto-stereoscope module 301 performs an auto-stereoscopic operation on the surface. That is, the auto-stereoscope module 301 compresses the surface, divides the surface into a top part and a bottom part, draws the top part and the second part individually, and combines the drawn top part and bottom part into a complete surface.

In step S38, the entire surface is drawn. When the surface is already a 3D surface in a top-bottom image, the entire surface can be drawn without performing the auto-stereoscopic operation.

In step S36, the management server 32 determines whether a current surface is an uppermost surface. Step S39 is performed when a determination result is affirmative, or else step S37 is performed when the determination result is negative.

In step S37, a surface of one layer up is obtained. After processing one surface, the management server 32 obtains and processes the surface of one layer up.

The process ends in step S39.

After having drawn all the visible surfaces, the drawn surfaces are rendered and then outputted by the rendering module 302 to the frame buffer 33. The graphics processor 34 processes data frame buffered by the frame buffer 33, and outputs processed results to the display module 35 for display. Operations details of the graphics processor 34 are identical to those in the description associated with the two application scenarios above, and shall be omitted herein.

### Second Embodiment

A 3D user interface display method according to an embodiment comprises the following steps.

In step S0, an attribute of a surface is set. The attribute corresponds to a processing method of the graphics processor.

In step S1, it is determined whether each visible surface is a 2D surface or a 3D surface. Step S2 is performed when the visible surface is a 2D surface, or else step S3 is performed when the visible surface is a 3D surface.

In step S2, since the 2D surface and the 3D surface coexists in the visible surfaces, an auto-stereoscopic operation is performed on the 2D surface according to a mode adopted by the 3D surface. In step S2, when the 3D surface is a 3D surface having a top part and a bottom part with parallax, the entire 2D surface is compressed and divided into a top part and a bottom part, the top part and the bottom part are individually drawn and then combined into a complete surface. Alternatively, when the 3D surface is a 3D surface having a left part and a right part with parallax, the entire 2D surface is compressed and divided into a left part and a right part, and the left part and the right part are individually drawn and then combined into a complete surface.

In step S3, all the surfaces are rendered by the rendering module 302 in the management server 32.

In step S4, the rendered surfaces in step S3 are frame buffered.

In step S5, the graphics processor 34 interleaves odd and even fields of the surfaces, or interpolates the surfaces according to different attributes. More specifically, according to surface attributes, odd and even fields of the surfaces frame buffered in step S4 are interleaved, or the surfaces frame buffered in step S4 are interpolated by the graphics processor 34.

Step S5 comprises interleaving odd and even fields of the frame buffered surfaces. When interleaving odd and even fields, odd and even fields of an image outputted after frame buffering are interleaved to obtain an image having an odd field and an even field with different polarizations. In such situation, two images with parallax may be observed by a user through a pair of polarized glasses to form a stereoscopic surface giving a stereoscopic effect and sense of depth.

Step S5 comprises interpolating the frame buffered surfaces. The frame buffered surfaces are divided into two parts for interpolation, and interpolated results are sequentially outputted as two frames. In such situation, the frames may be received by a pair of glasses of left and right lenses having an alternating switch function, so that one of the frames is visible through the left lens while the other is only visible through the right lens. The interpolation module further sends synchronization signals for controlling the switching of the left and right lenses, in a way that a time difference between time points at which the two frames are received by the left and right lenses is too small to be noticed. Thus, the left and right lenses are allowed to almost simultaneously receive the two surfaces with parallax to form a stereoscopic surface giving a stereoscopic effect and sense of depth in the human brain.

In step S6, the surface in step S5 is displayed.

In the 3D user interface display system and associated method of the present invention, different operations are performed for surfaces of different attributes according to whether the surfaces are 2D or 3D surfaces, so as to better display a 3D user interface on an electronic apparatus.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A three-dimensional (3D) user interface display system, comprising:
a surface type determination module, for determining whether a visible surface is a two-dimensional (2D) surface or a 3D surface;
a management server, for drawing and rendering the visible surface, comprising:
an auto-stereoscope module, for performing an auto-stereoscopic operation on the 2D surface in the visible surface; and
a rendering module, for rendering the visible surface;
a frame buffer module, for frame buffering the surface rendered by the rendering module;
a graphics processor, for performing a graphics process on the frame buffered surface; and
a display module, for displaying the surface processed by the graphics processor.

2. The 3D user interface display system according to claim 1, wherein the auto-stereoscope module compresses the 2D surface, divides the compressed 2D surface into a top part and a bottom part, draws the top part and the bottom part individually, and combines the drawn top part and bottom part into a complete surface.

3. The 3D user interface display system according to claim 1, wherein the graphics processor comprises:
an odd-even-field interleaving module, for interleaving odd and even fields of the frame buffered surface.

4. The 3D user interface display system according to claim 3, wherein the odd-even-field interleaving module interleaves the odd and even fields of the frame buffered surface to obtain an image having an odd and an even field that have different polarizations.

5. The 3D user interface display system according to claim 1, wherein the graphics processor comprises:
an interpolation module, for interpolating the frame buffered surface.

6. The 3D user interface display system according to claim 5, wherein the interpolation module divides the frame buffered surface as two parts for interpolation, sequentially outputs interpolation results as two frames, receives the frames corresponding to a pair of glasses of left and right lenses having an alternating function; one of the frames is visible through the left lens and the other frame is visible to the right lens; the interpolation module further sends a synchronization signal for controlling the alternating function of the left and right lenses of the glasses.

7. The 3D user interface display system according to claim 1, wherein the surface displayed by the 3D user interface display system is formed from superimposing a plurality of surfaces processed by the graphics processor.

8. The 3D user interface display system according to claim 1, wherein the management server further comprises an attribute configuration module for setting an attribute of the surface; the graphics processor determines whether to interleave the odd and even fields of the surface or to interpolate the surface according to the attribute.

9. The 3D user interface display system according to claim 8, wherein the attribute configuration module adds a stereoscopic attribute to the surface, and the stereoscopic attribute indicates whether to perform the auto-stereoscopic operation on the visible surface, and has a true default value; the attribute configuration module further determines whether the visible surface is the 2D surface or the 3D surface; when the visible surface is the 3D surface, the auto-stereoscopic operation is not performed, and the stereoscopic attributes is set to false; when the visible surface is the 2D surface, the stereoscopic operation is performed, and the stereoscopic attribute is maintained at the true default value.

10. The 3D user interface display system according to claim 9, wherein the management server obtains a lowermost surface and checks the stereoscopic attribute of the lowermost surface; when the stereoscopic attribute of the lowermost surface is true, said server compresses an entire surface, dividing the surface into either a top part and a bottom part or a left part and a right part, draws the top part and the bottom part or the left part and the right part individually, and combines the drawn top part and bottom part or the drawn left part and right into a complete surface; when the stereoscopic attribute is false, said server indicates that the surface is a top-bottom or left-right stereoscopic surface, does not perform the auto-stereoscopic operation on the lowermost surface and draws only the entire frame; when the lowermost surface is drawn, said server obtains and draws a surface one layer up; the rendering module renders all the visible surfaces when all surfaces are drawn.

11. A 3D user interface display method, comprising:
S1: determining whether a visible surface is a 2D surface or a 3D surface;
S2: drawing the visible surface, comprising:
S20: performing an auto-stereoscopic operation on the 2D surface in the visible surface;
S3: rendering the visible surface;
S4: frame buffering the surface rendered in step S3;
S5: performing a graphics process on the surface frame buffered in step S4; and
S6: displaying the surface processed in step S5.

12. The 3D user interface display method according to claim 11, wherein the auto-stereoscopic process in step S20 compresses the 2D surface, divides the compressed 2D surface into a top part and a bottom part, individually draws the top part and the bottom part, and combines the drawn top part and bottom part into a complete surface.

13. The 3D user interface display method according to claim 11, wherein the graphics process in step S5 comprises interleaving odd and even fields of the frame buffered surface.

14. The 3D user interface display method according to claim 13, wherein the step of interleaving the odd and even fields, interleaves the odd and even fields of the frame buffered surface to obtain an image having an odd field and an even field that have different polarizations.

15. The 3D user interface display method according to claim 11, wherein the graphics process in step S5 comprises interpolating the frame buffered surface.

16. The 3D user interface display method according to claim 15, wherein the interpolating step further comprises:
dividing the frame buffered surface into two parts for interpolation;
outputting interpolation results as two frames sequentially;
receiving the frames corresponding to a pair of glasses of left and right lenses, wherein said lenses have an alternating function, wherein one of the frames is visible through the left lens and the other frame is visible to the right lens; and
sending a synchronization signal for controlling the alternating function of the left and right lenses of the glasses.

17. The 3D user interface display method according to claim 11, wherein step S2 further comprises setting an attribute of the surface; in step S5, the graphics process interleaves the odd and even fields of the surface or interpolates the surface according to the attribute.

18. The 3D user interface display method according to claim 17, wherein the step of setting the attribute comprises:
S11: assigning a unique identity mark to the visible surface by calling a corresponding function after establishing the visible surface of the user interface;
S12: adding a stereoscopic attribute to the surface, wherein the stereoscopic attribute indicates whether to perform the auto-stereoscopic operation on the visible surface, and has a true default value; and
S13: determining whether the visible surface is the 2D surface or the 3D surface; when the visible surface is the 3D surface setting the stereoscopic attributes to false; when the visible surface is the 2D surface, performing the stereoscopic operation, and maintaining the stereoscopic attribute at the true default value.

19. The 3D user interface display method according to claim 18, wherein step S2 comprises:
starting to draw after setting the stereoscopic attribute of all the visible surface;
obtaining a lowermost surface and checking the stereoscopic attribute of the lowermost surface;
compressing an entire surface, dividing the surface into a top part and a bottom part or a left part and a right part, individually drawing the top part and the bottom part or the left part and the right part, and combining the drawn top part and bottom part or the drawn left part and right into a complete surface, if the stereoscopic attribute of the lowermost surface is true;
indicating that the surface is a top-bottom or left-right stereoscopic surface, not performing the auto-stereoscopic operation on the lowermost surface and drawing the entire frame, if the stereo attribute is false;
obtaining and drawing a surface one layer up, if the lowermost surface is drawn; and
rendering all the visible surfaces when all surfaces are drawn.
